(19) United States
(12) Patent Application Publication
(10) Pub. No.: US 2007/0198865 A1
(43) Pub. Date: Aug. 23, 2007

(54) Computer system apparatus

(75) Inventor: Sen Jan, Taoyuan City (TW)

Correspondence Address: TROXELL LAW OFFICE PLLC, SUITE 1404, 5205 LEESBURG PIKE, FALLS CHURCH, VA, 22041, US

(73) Assignee: SPI Electronic Co., Ltd.

(21) Appl. No.: 11/397,622

(22) Filed: Apr. 5, 2006

(30) Foreign Application Priority Data
Feb. 22, 2006 (TW) 95202963

(51) Int. Cl. G06F 1/00

(52) U.S. Cl. 713/300

(57) ABSTRACT

The present invention discloses a computer system that installs a main power supply and at least one auxiliary power supply, and the auxiliary power supply is built in the casing or externally connected to the circuit of a computer system apparatus, such that the auxiliary power supply shares supplying electric power required for the operations of all equipments of the computer system, so as to assure the stability of the operations of the computer system, and improving the performance of the computer system.

### BACKGROUND OF THE INVENTION

1. Field of the Invention

The present invention relates to a power supply of a computer system, and more particularly to an auxiliary power supply that assists supplying electric power required for the operations of the computer system, so as to assure a stability of the operations of the computer system and improve the performance of the computer system.

2. Description of the Related Art

Referring to FIGS. 1 and 2 for the basic architecture of a general computer system, the computer system comprises a casing 11 as its body, and the casing 11 installs major built-in components such as a motherboard 12, a microprocessor 13, a hard disk drive 14, an optical disk drive 15, and a display chip module 16 and includes a power supply 17 for converting public utility AC(altemating current) electric power into DC(direct current) electric power required for the operations of the computer system. Therefore, the power supply 17 is the power source for the computer system apparatus that determines the stability of the operations and the long-use quality of the computer system.

Since the power source of the computer system apparatus comes from a DC power converted by the power supply, the basic architecture of a computer system can use a single 300 W(watt) power supply to meet the power consumption requirement of the basic components installed on the motherboard. However, the operating speeds of the microprocessor and the display chip module are increased, and thus the overall power consumption of the computer system will increase greatly, particularly for an upgrade to an enhanced display chip module. Therefore, the general single power supply sold in the market may not be able to maintain a normal operation of the overall computer system apparatus, or may even damage the related equipments due to the unstable currents.

### SUMMARY OF THE INVENTION

In view of the shortcomings of the prior art, the inventor of the invention based on years of experience in the related industry to conduct extensive researches and experiments, and finally invented a computer system apparatus in accordance with the invention.

Therefore, it is a primary objective of the present invention to use an auxiliary power supply to supply the electric power required for the operations of all equipments of the computer system to assure the stability of the operations and improve the performance of the apparatus.

In an embodiment of the invention, the computer system installs a primary power supply and at least one auxiliary power supply, and the auxiliary power supply is built in the casing or externally connected to couple with the circuit of the computer system, so as to assist the power supply to share supplying electric power required by the equipments, stabilize the operations of the apparatus, and improve the operating performance.

### BRIEF DESCRIPTION OF THE DRAWINGS

The present invention will now be described in more detail hereinafter with reference to the accompanying drawings that show various embodiments of the invention, in which:

FIG. 1 is a perspective view of a prior art computer system apparatus;

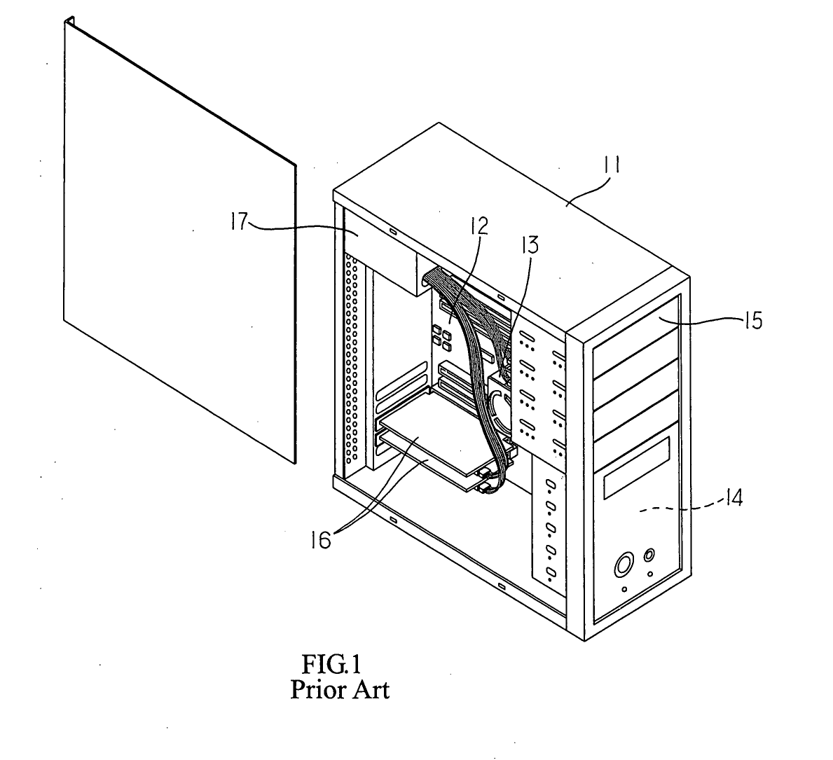

FIG. 2 is a planar view of a prior art computer system apparatus;

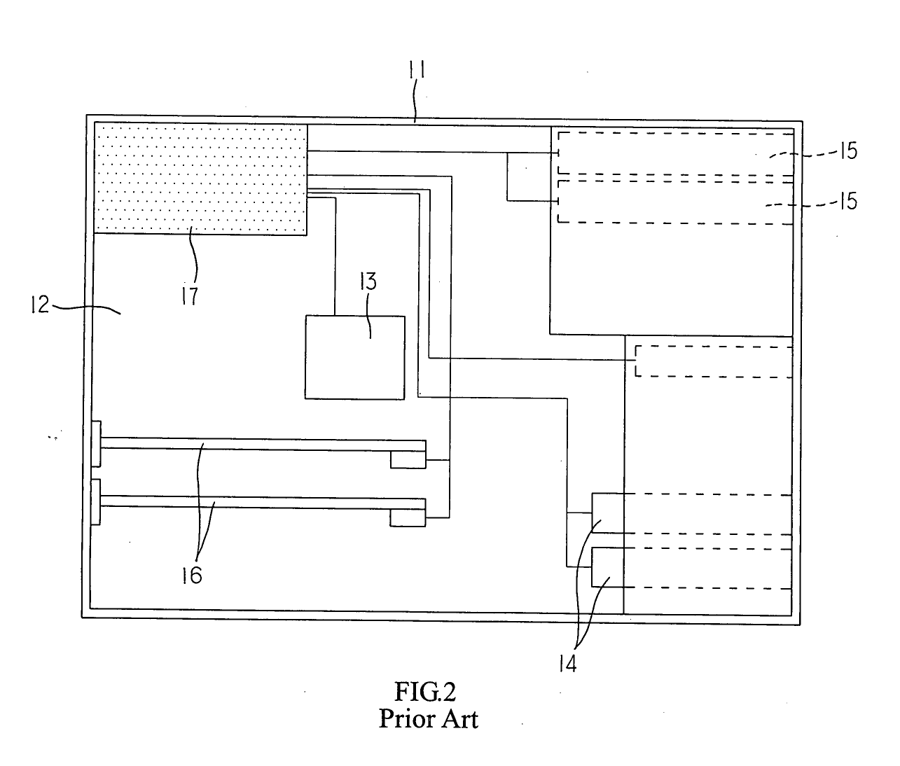

FIG. 3 is a perspective view of a computer system apparatus according to a first preferred embodiment of the present invention;

FIG. 4 is a planar view of a computer system apparatus according to a first preferred embodiment of the present invention;

FIG. 5 is a perspective view of a computer system apparatus according to a second preferred embodiment of the present invention;

FIG. 6 is a schematic view of the layout of a power input port and a power output port of an auxiliary power supply according to the present invention;

FIG. 7 is a perspective view of a computer system apparatus according to a third preferred embodiment of the present invention;

FIG. 8 is a planar view of a computer system apparatus according to a third preferred embodiment of the present invention; and

FIG. 9 is a perspective view of a computer system apparatus according to a fourth preferred embodiment of the present invention;

### DETAILED DESCRIPTION OF THE PREFERRED EMBODIMENTS

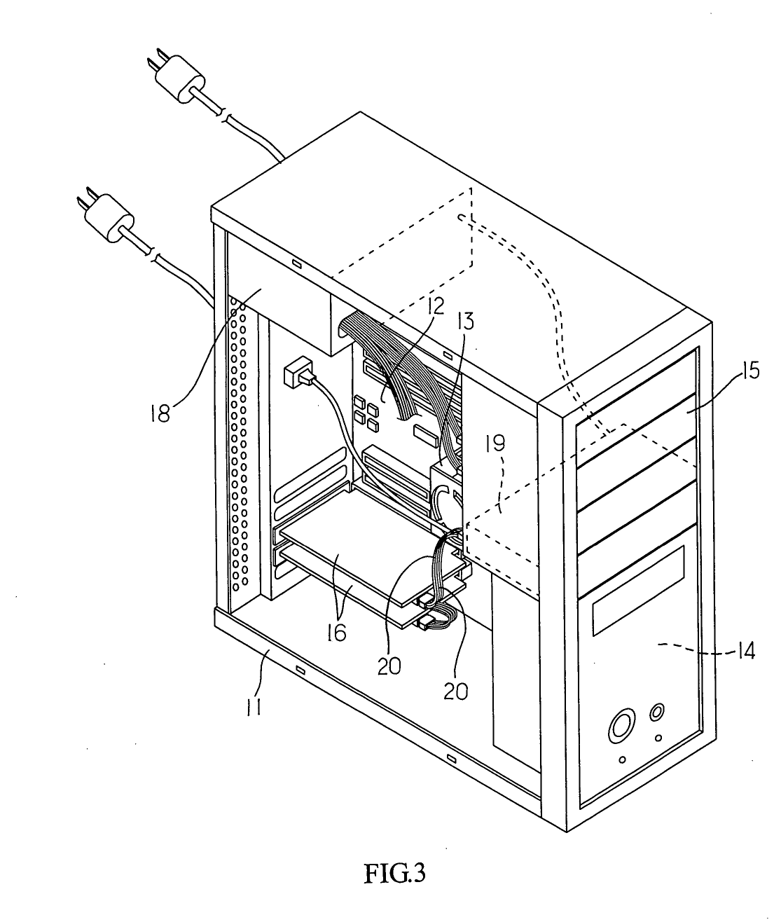

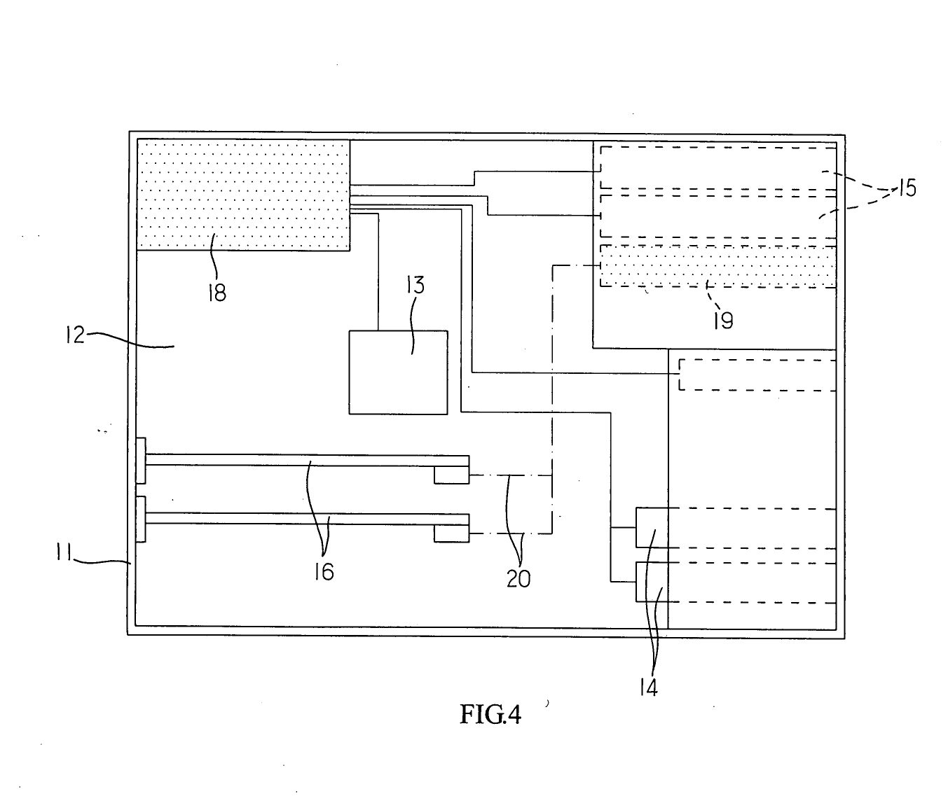

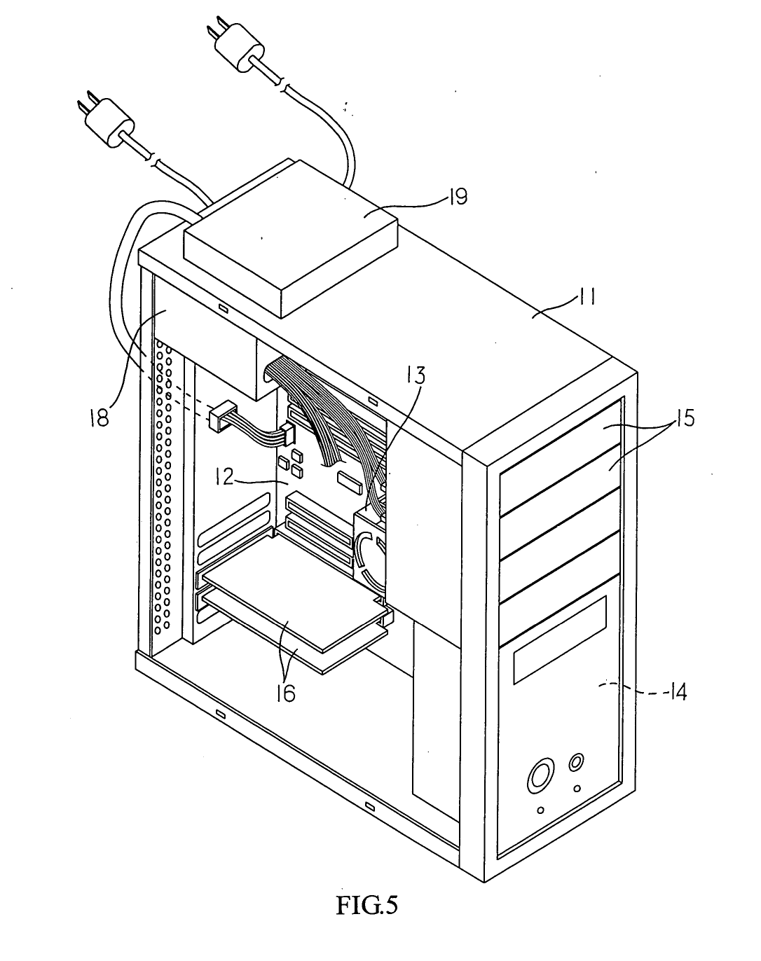

Referring to FIGS. 3 and 4 for the computer system apparatus, the computer system includes a casing 11, and the casing 11 installs built-in components such as a motherboard 12, a microprocessor 13, a hard disk drive 14, an optical disk drive 15, a display chip module 16, and a primary power supply 18, and the casing 11 further includes an auxiliary power supply 19 built in the casing 11 as shown in FIGS. 3 and 4 or the auxiliary power supply is externally connected to the computer system as shown in FIG. 5.

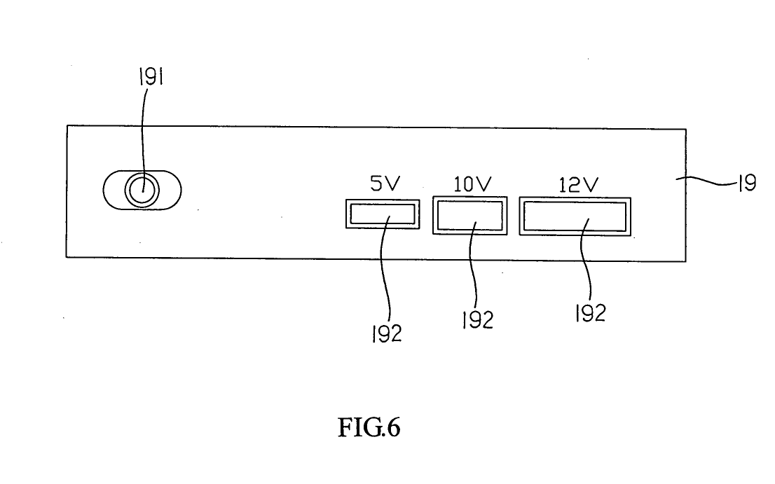

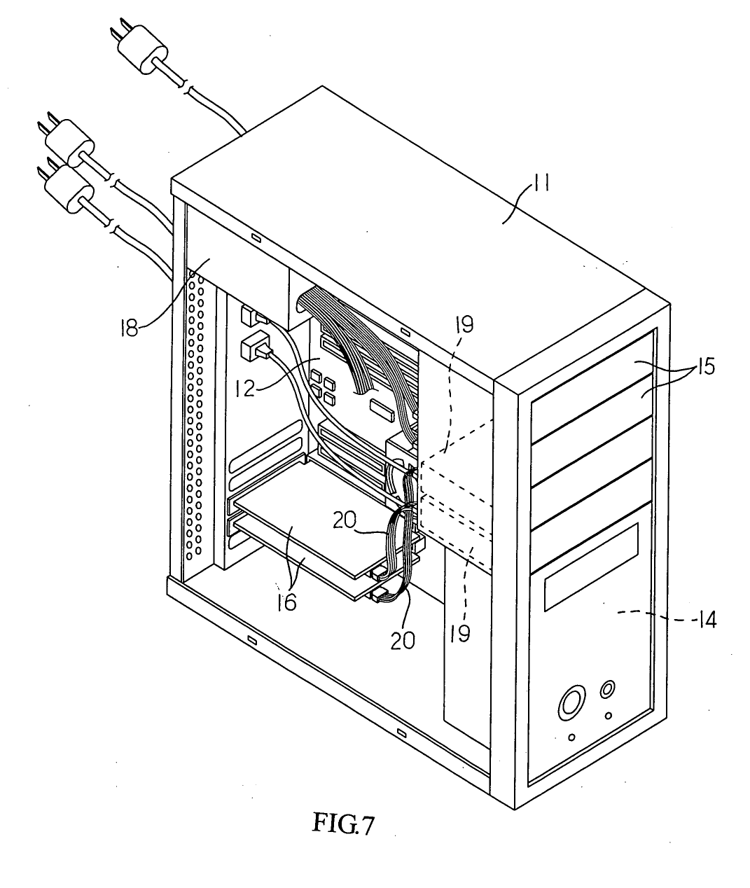

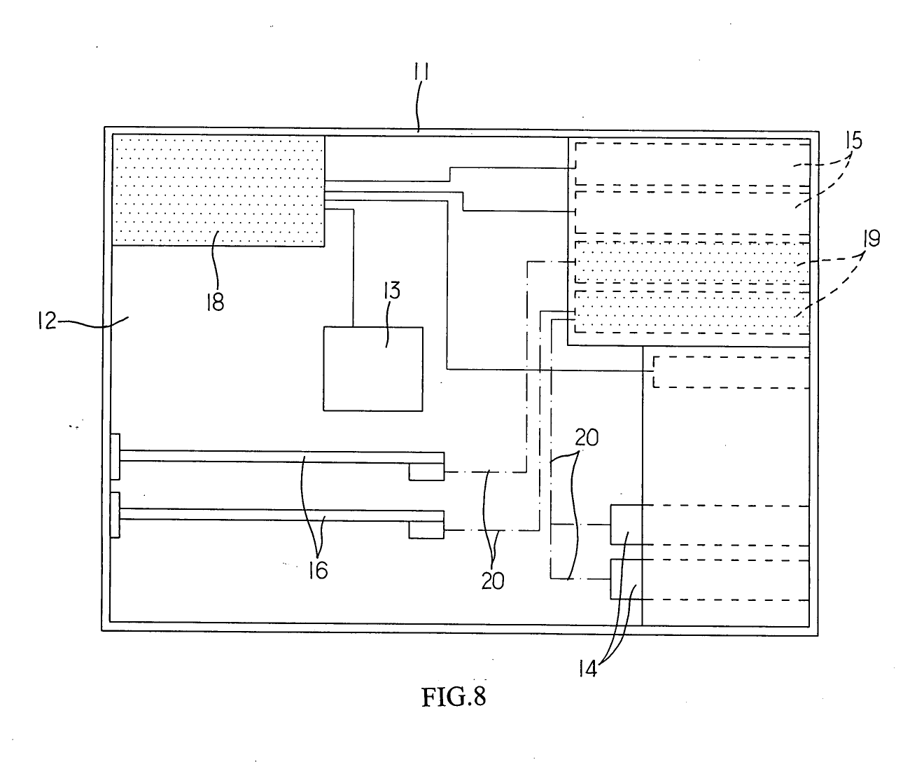

Referring to FIG. 6, each auxiliary power supply 19 includes a power input port 191 and a plurality of power output ports 192 for supplying 5V(voltage), 10V, 12V DC power for the computer system equipment, or supplying −48V to 48V DC power required by different equipments (such as −48V and −24V for communication equipments or motors, and 24V, 36V, or 48V for networking equipments), and the quantity of the auxiliary power supplies 19 can be added according to actual needs as shown in FIGS. 7 and 8, so that the auxiliary power supplies 19 can share supplying the electric power required for the operations of all equipments of the computer system to assure the stability of operations and improve the operating performance of the apparatus.

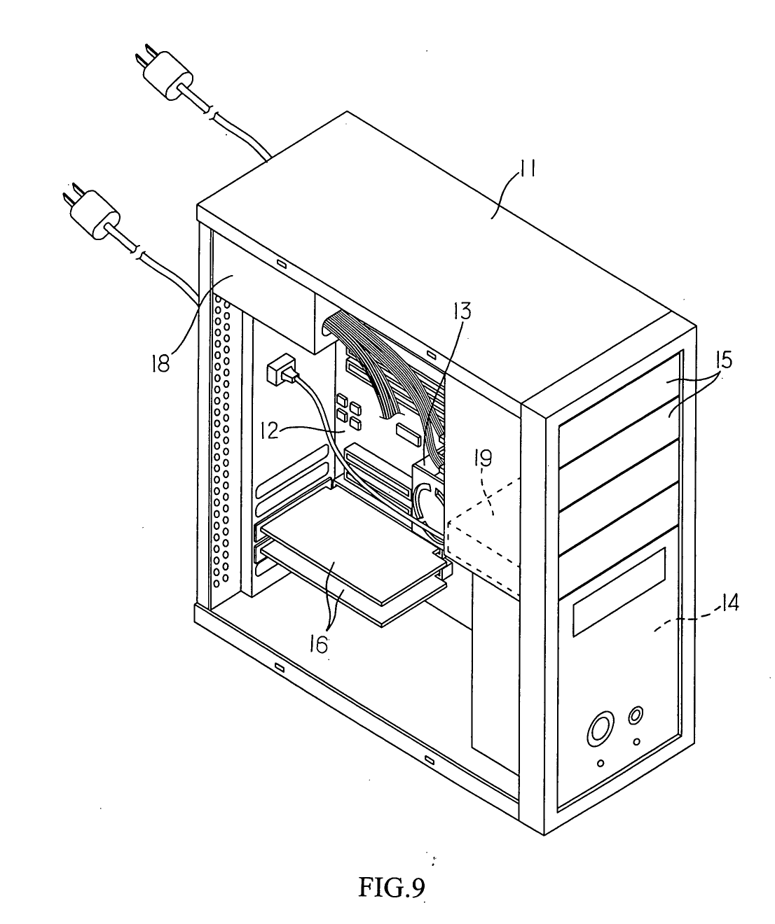

In an embodiment, the output power of the auxiliary power supply 19 can be supplied for the operations of equipments (such as a microprocessor, a display chip module, a hard disk drive, an optical disk drive, and a floppy disk drive) in addition to the motherboard 12. Referring to FIG. 3 for the preferred embodiment of the present invention, the auxiliary power supply 19 is connected to a computer system apparatus (such as the display chip module 16) through a power cable 20 and sent the electric current to the connected equipments through the power cable 20. Of course, the power supply circuit and the related power detect circuit of the auxiliary power supply 19 can be built directly on the motherboard 12 as shown in FIGS. 5 and 9 for sending the electric power to the power supply target (such as the display chip module 16 as shown in the figure) of the auxiliary power supply 19 through the motherboard 12 to improve the convenience of installing the auxiliary power supply 19 and avoid too many cables causing a poor cable management inside the casing 11.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A computer system apparatus, installing a primary power supply and at least one auxiliary power supply, and said each auxiliary power supply being built in a casing and electrically coupled to a circuit of a computer system.

2. A computer system apparatus, installing a primary power supply and at least one auxiliary power supply, and said each auxiliary power supply being connected externally and electrically to a circuit of a computer system.

3. The computer system apparatus of claims 1, comprising a motherboard, a microprocessor, a hard disk drive, an optical disk drive, a display chip module built in said casing.

4. The computer system apparatus of claims 2, comprising a motherboard, a microprocessor, a hard disk drive, an optical disk drive, a display chip module built in said casing.

5. The computer system apparatus of claim 3, wherein said auxiliary power supply supplies an electric power required for the operations of said microprocessor, said hard disk drive, said optical disk drive, and said display chip module.

6. The computer system apparatus of claim 4, wherein said auxiliary power supply supplies an electric power required for the operations of said microprocessor, said hard disk drive, said optical disk drive, and said display chip module.

7. The computer system apparatus of claim 3, wherein said auxiliary power supply supplies an electric power to a power supply target through a power cable.

8. The computer system apparatus of claim 4, wherein said auxiliary power supply supplies an electric power to a power supply target through a power cable.

9. The computer system apparatus of claim 3, wherein said motherboard includes a power supply circuit and a related power supply detect circuit built of said auxiliary power supply, and said power supply sends the electric power to said power supply target through said motherboard.

10. The computer system apparatus of claim 4, wherein said motherboard includes a power supply circuit and a related power supply detect circuit built of said auxiliary power supply, and said power supply sends the electric power to said power supply target through said motherboard.

11. The computer system apparatus of claims 1, wherein said auxiliary power supply includes a power input port and at least one power output power.

12. The computer system apparatus of claims 2, wherein said auxiliary power supply includes a power input port and at least one power output power.

13. The computer system apparatus of claims 1, wherein said auxiliary power supply supplies a direct current of 5V, 10V, or 12V.

14. The computer system apparatus of claims 2, wherein said auxiliary power supply supplies a direct current of 5V, 10V, or 12V.

15. The computer system apparatus of claims 1, wherein said auxiliary power supply supplies a direct current from −48V to 48V.

16. The computer system apparatus of claims 2, wherein said auxiliary power supply supplies a direct current from −48V to 48V.
